(19) United States
(12) Patent Application Publication
(10) Pub. No.: US 2019/0375510 A1
(43) Pub. Date: Dec. 12, 2019

(54) UNMANNED AERIAL VEHICLE

(71) Applicant: SZ DJI TECHNOLOGY CO., LTD., Shenzhen (CN)

(72) Inventors: Li QIU, Shenzhen (CN); Mingxi WANG, Shenzhen (CN)

(21) Appl. No.: 16/548,349

(22) Filed: Aug. 22, 2019

Related U.S. Application Data
(63) Continuation of application No. PCT/CN2017/074820, filed on Feb. 24, 2017.

(51) Int. Cl. B64D 27/24; H01M 2/10; B64C 39/02; B64D 47/08

(52) U.S. Cl. CPC B64D 27/24; H01M 2/1083; B64C 39/024; B64C 2201/042; H01M 2220/20; B64C 2201/027; B64D 47/08

(57) ABSTRACT

An unmanned aerial vehicle (UAV) includes: a fuselage and a battery module. The fuselage has a bottom facing a ground level. The battery module includes a battery. The battery has a top portion facing the bottom of the fuselage. The top portion of the battery is disposed below the bottom of the fuselage.

### CROSS-REFERENCE TO RELATED APPLICATION

This application is a continuation application of International Application No. PCT/CN2017/074820, titled “Unmanned Aerial Vehicle”, filed on Feb. 24, 2017, the entire contents of which are incorporated herein by reference.

### TECHNICAL FIELD

The present disclosure relates to the field of unmanned aerial vehicles (UAVs), and in particular to an UAV.

### BACKGROUND

The battery of an UAV is usually installed in the fuselage of the UAV, which may result in a higher center of gravity and a weaker wind resistance performance of the UAV.

### SUMMARY

The present disclosure provides an unmanned aerial vehicle (UAV). The UAV includes a fuselage and a battery module. The fuselage has a bottom facing a ground level. The battery module includes a battery. The battery has a top portion facing the bottom of the fuselage. The top portion of the battery is disposed below the bottom of the fuselage.

In certain embodiments, the battery module further includes a battery connection base. The battery connection base is coupled to the bottom of the fuselage. The battery connection base and the bottom of the fuselage form a battery compartment for housing the battery.

In certain embodiments, the battery is longitudinally disposed on the bottom of the fuselage along a roll axis of the fuselage.

In certain embodiments, a projected area of the fuselage toward the battery module is larger than a projected area of the battery module toward a downward direction.

In certain embodiments, the battery connection base further includes a circuit board and an electric connector. The battery further includes an electric connection terminal. The electric connection terminal is electrically connected to the electric connector. The circuit board is electrically connected to the fuselage.

In certain embodiments, the battery connection base includes a connecting portion and a carrying portion. The circuit board is disposed in the connecting portion. The carrying portion is parallel to the bottom of the fuselage. The battery compartment is formed between the carrying portion and the bottom of the fuselage.

In certain embodiments, a bottom end of the carrying portion is provided with an ultrasonic sensor.

In certain embodiments, a bottom end of the carrying portion is provided with a binocular vision sensor.

In certain embodiments, the connecting portion is provided with a power switch.

In certain embodiments, the connecting portion is provided with a light indicator.

In certain embodiments, the battery is slidably disposed in the battery compartment along a roll axis of the fuselage.

In certain embodiments, the UAV further includes a gimbal disposed on the bottom of the fuselage, and the gimbal and the battery module are respectively located on two opposite ends of the fuselage.

In certain embodiments, the gimbal is located at a front end of the bottom of the fuselage, and the battery module is located at a rear end of the bottom of the fuselage.

In certain embodiments, the gimbal is a first gimbal; the UAV further includes a second gimbal; and the first gimbal and the second gimbal are placed side-by-side at a same end of the fuselage.

In certain embodiments, the gimbal is provided with a load.

In certain embodiments, a bottom end of the battery is higher than the UAV load.

In certain embodiments, the load includes a camera.

In certain embodiments, the load is rotatable for 360° about a yaw axis with respect to the gimbal.

The above aspects will be explained in detail with accompanying drawings.

### BRIEF DESCRIPTION OF THE DRAWINGS

In order to more clearly illustrate the technical solutions provided by the present disclosure, the drawings used in the description of the embodiments will be briefly described below, wherein:

FIG. 1 is a side view of an UAV according to certain embodiments of the present disclosure;

FIG. 2 is a top view of the UAV of FIG. 1;

FIG. 3 is a side view of a battery module of a UAV according to certain embodiments of the present disclosure; and

FIG. 4 is a bottom view of the battery module of FIG. 3.

### DETAILED DESCRIPTION OF THE EMBODIMENTS

The embodiments of the present disclosure are described in detail below. The embodiments are illustrated in the drawings, wherein the same or similar reference numerals may indicate the same or similar elements or elements having the same or similar functions. The embodiments described below with reference to the drawings are intended to be illustrative of the disclosure and are not to be construed as limiting.

In the present disclosure, it is to be understood that orientational or positional relationships indicated by terms such as “center”, “longitudinal”, “lateral”, “length”, “width”, “thickness”, “upper”, “lower”, “front”, “back”, “left”, “right”, “vertical”, “horizontal”, “top”, “bottom”, “inside”, “outside”, “clockwise”, “counterclockwise”, etc., may be based on the orientational or positional relationships shown in the drawings, and are merely for the convenience of the description of the present disclosure. They may not be intended to indicate or imply that the device or component referred to has a specific orientation. Therefore, they should not be construed as limiting the disclosure. Moreover, the terms “first” and “second” may be used for descriptive purposes only and are not to be construed as indicating or implying a relative importance or implicitly indicating the quantity of technical features indicated. Thus, features defining “first” or “second” may include one or more of the described features either explicitly or implicitly. In the description of the present disclosure, the meaning of “a plurality” may be referred to two or more unless specifically defined.

In the description of the present disclosure, it should be noted that terms such as “installed”, “connected”, and “connection” should be understood broadly. For example, a connection may be a fixed, a detachable, or an integral connection. The connection may refer to a mechanically connection, an electrically connection, or a communication link. The connection may be a direct connection, an indirect connection through an intermediate medium, or a communication or interaction of two elements. For those skilled in the art, the specific meanings of the above terms in the present disclosure may be understood on a case-by-case basis.

In the present disclosure, unless otherwise defined, when it is stated that a first feature is “on” or “under” a second feature, it may include a direct contact of the first and second features, and may also include an indirect contact of the first and second features through additional features. Moreover, when it is stated that the first feature is “above” the second feature, it may include the first feature being directly above the second feature, or merely indicating that the first feature is in a position higher than the second feature. When it is stated that the first feature is “below” the second feature, it may include the first feature being directly below the second feature, or merely indicating the first feature being at a position lower than the second feature.

The following disclosure provides multiple embodiments or examples for implementing different structures. In order to simplify the description, the components and arrangements of the specific examples are described below. They are merely examples and are not intended to limit the disclosure. In addition, the present disclosure may use repeated reference numerals in various examples, which are for the purpose of simplicity and clarity, and do not indicate the relationship between the various embodiments and/or arrangements discussed. Moreover, the present disclosure provides examples of various specific processes and materials, but one of ordinary skill in the art will recognize the use of other processes and/or other materials.

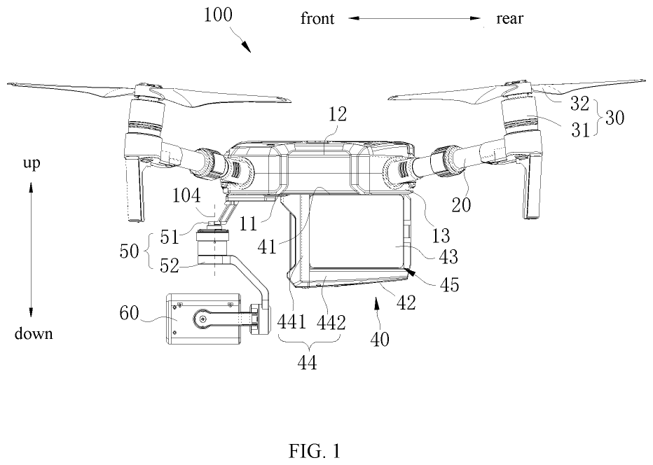

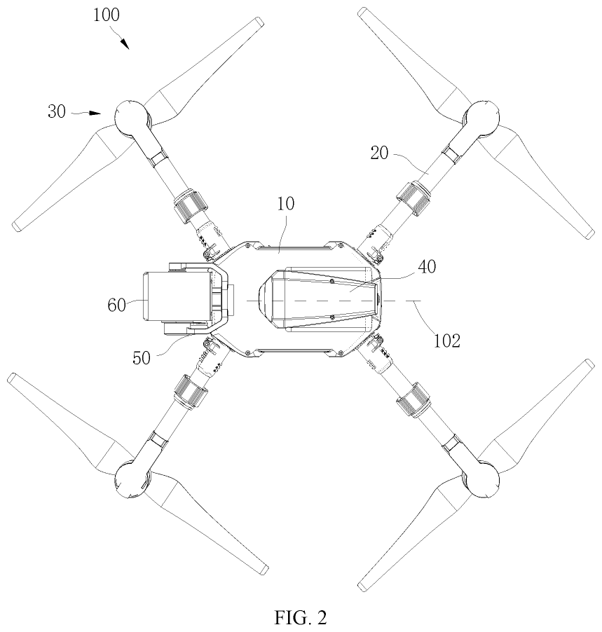

Referring to FIG. 1 and FIG. 2, according to certain embodiments, a UAV 100 may be a rotor UAV. The UAV 100 may fly and hover in the air to perform specific tasks, such as flying, tracking, monitoring, exploration, search and rescue, sowing seeds, spraying pesticides, firefighting, aerial photography, and so on. The UAV 100 may be equipped with functional modules, such as sensors, imaging devices, medicine boxes, etc., to perform certain functions.

According to certain embodiments, the UAV 100 may include a fuselage 10, one or more arms 20, one or more rotor assemblies 30, a battery module 40, and a gimbal 50. The arms 20 may project outwardly from the fuselage 10. The rotor assemblies 30 may be mounted on the arms 20 and located around the fuselage 10.

In certain embodiments, the UAV 100 may be a quadrotor UAV, and correspondingly, the number of rotor assemblies 30 may be four. The four rotor assemblies 30 may be symmetrically distributed about a vertical center axis of the fuselage 10 to balance the UAV 100.

In certain other embodiments, the number of rotor assemblies 30 may be other numbers depending on the applications. For example, the number of rotor assemblies 30 may be one, two, three, six, eight, and so on.

The fuselage 10 may be a carrier. Components such as a sensor, a circuit board, a central processing unit (CPU), and a communication module may be carried on or in the fuselage 10. The fuselage 10 may have a streamlined shape to reduce air resistance during flight. In certain other embodiments, the fuselage 10 may have other shapes, such as polygonal, circular, elliptical, and the like.

The fuselage 10 may include a bottom 11. When the UAV 100 is flying normally, the bottom 11 may face the ground. The surface of the bottom 11 facing the ground may be a flat surface or a curved surface. In certain embodiments, the surface of the bottom 11 facing the ground is a flat surface.

In certain embodiments, the fuselage 10 may include an upper housing 12 and a lower housing 13. The upper housing 12 may mate with the lower housing 13. The upper housing 12 and the lower housing 13 may be connected together by a buckle structure, or a threaded connection or the like. The upper housing 12 and the lower housing 13 may form an interior space of the fuselage 10. The lower housing 13 may include the bottom 11 of the fuselage 10. A battery module 40 may be coupled to the lower housing 13.

The arms 20 may be used to support the rotor assemblies 30 and distribute the rotor assemblies 30 around the fuselage 10 in a predetermined pattern. In certain embodiments, the number of the arms 20 is four, and each of the arms 20 supports one rotor assembly 30. One end of each arm 20 may be coupled to the fuselage 10 and the other end may support the rotor assembly 30.

The rotor assembly 30 may include a motor 31 and a propeller 32. The motor 31 may be mounted on the arm 20, and the propeller 32 may be coupled to the motor 31. The motor 31 may drive the propeller 32 to rotate during operation to drive the UAV 100 to fly.

In certain embodiments, the battery module 40 may have a rectangular shape. The battery module 40 may include a top portion 41 and a bottom portion 42. The top portion 41 of the battery module 40 may face the bottom 11 of the fuselage 10, and the bottom portion 42 of the battery module 40 may be opposite to the top portion 41 and face the ground. The top portion 41 of the battery module 40 may be coupled to the bottom 11 of the fuselage 10. For example, the top portion 41 of the battery module 40 and the bottom 11 of the fuselage 10 may be connected by a detachable structure such as a rail connection or a snap connection to facilitate the detachment of the battery module 40 from the fuselage 10. In some embodiments, the battery module 40 may also be a cylindrical structure, a triangular prism structure, an elliptical cylinder structure, or a cylinder structure having other polygonal cross-sections.

In some embodiments, a projected area of the fuselage 10 toward the battery module 40 may be greater than a projected area of the battery module 40 facing downward. That is to say, the size of the fuselage 10 may be larger than the battery module 40.

In order to facilitate the installation of the battery module 40 and to balance the center of gravity of the UAV 100, the battery module 40 may be coupled to the bottom 11 of the fuselage 10 along a roll axis 102 of the fuselage 10. The roll axis 102 may extend in the front-back direction of the UAV 100. The front direction may refer to a forward direction of the flight of the UAV 100. The back direction may refer to the opposite direction of the forward direction of the flight of the UAV 100.

The UAV 100 may be tilted about the roll axis 102 during flight to change a flight attitude. For example, the UAV 100 may be rolled during flight to perform a turn.

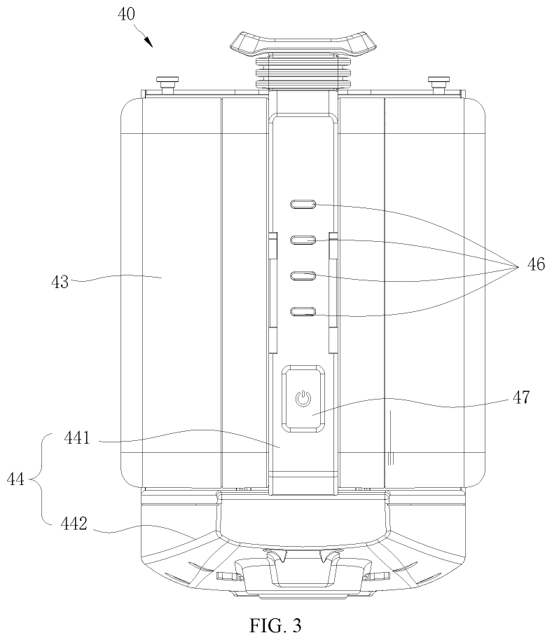

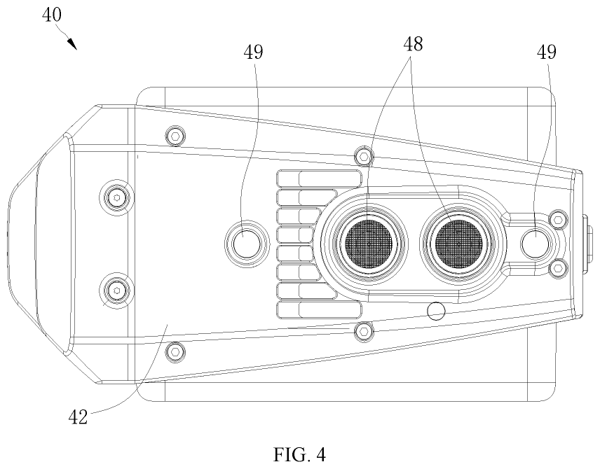

Referring to FIGS. 3 and 4, the battery module 40 may include a battery 43, a battery connection base 44, a switch 46, an indicator light 47, an ultrasonic sensor 48, and a vision sensor 49.

The battery 43 may have a top portion 41 facing the bottom 11 of the fuselage 10. The top portion 41 may be disposed below the bottom 11 of the fuselage 10. The battery 43 may be configured on the bottom 11 of the fuselage 10 along the longitudinal roll axis 102 of the fuselage 10. The battery may supply power to the rotor assembly 30 and drive the UAV 100 in flight.

The battery connection base 44 may be connected to the bottom 11 of the fuselage 10. The battery connection base 44 and the bottom 11 may form a battery compartment 45 for housing the battery 43. The battery 43 may be longitudinally disposed in the battery compartment 45 along the roll axis 102 of the fuselage 10.

In certain embodiments, the battery connection base 44 may be provided with a circuit board (not shown) and an electrical connector (not shown). The battery 43 may be provided with electrical connection terminals (not shown), and the electrical connection terminals may be connected to the electrical connector to make an electrical connection between the battery 43 and the battery connection base 44. For example, the electrical connector may include a metal tab, and the connection terminal of the battery 43 may include a socket that mates with the metal tab. When the battery 43 is mounted, the metal tab may be inserted into the socket of the connection terminal to make the battery electrically connected to the battery connection base 44. The circuit board may be electrically connected to the fuselage 10. For example, the circuit board may be electrically connected to the fuselage 10 by a cable. This allows the battery 43 to be electrically connected to the fuselage 10 through a circuit board in the battery connection base 44.

The battery connection base 44 may include a connecting portion 441 and a carrying portion 442. The circuit board may be disposed in the connecting portion 441. The carrying portion 442 may be parallel to the bottom 11 of the fuselage 10. The connecting portion 441 may be essentially perpendicular to the bottom 11 of the fuselage 10. A battery compartment 45 may be formed between the carrying portion 442 and bottoms 11 of the fuselage 10. The connecting portion 441 may be connected to the fuselage 10. The battery 43 may be carried on the carrying portion 442. Thus, the battery connection base 44 may be a hollow structure. It may provide connection and support to the battery while maintaining a low weight, so as to reduce the weight of UAV 100 in order to improve flight range of the UAV 100.

The switch 46 may be configured on the battery connection base 44 and connected to the battery 43. The switch 46 may be used for controlling the discharge of the battery 43. For example, when the switch 46 is turned on, the battery 43 may supply electrical power to the UAV 100. When the switch 46 is turned off, the battery 43 may stop supplying electrical power to the UAV 100.

In certain embodiments, the switch 46 may be configured on the connecting portion 441. In certain other embodiments, the switch 46 may be disposed on the carrying portion 442.

The indicator light 47 may be disposed on the battery connection base 44 and may be electrically connected to the battery 43. The indicator light 47 may be disposed on the connecting portion 441. The indicator light 47 may be used to display an amount of power and/or an operating state of the battery 43.

For example, when the indicator light 47 is illuminated, it may indicate that the battery 43 can supply power to the UAV 100. When the indicator light 47 is turned off, it may indicate that the battery 43 has stopped supplying power to the UAV 100.

In certain embodiments, the number of the indicator lights 47 may be four. The number of illuminated indicator lights 47 may be proportional to the amount of remaining power of the battery 43. For example, when the amount of remaining power of the battery 43 is 100%, then all of the four indicator lights 47 may be illuminated. When the amount of remaining power of the battery 43 is 50%, only two indicator lights 47 may be illuminated. A user may determine the remaining power of the battery 43 based on the number of illuminated indicator lights 47.

In certain other embodiments, the meaning of the number and status of the indicator lights 47 may be configured according to the application. For example, the number of the indicator lights 47 may be six or another number, and the indicator lights 47 may be all illuminated, partially illuminated, constantly illuminated or blinking, etc.

An ultrasonic sensor 48 may be configured on the bottom portion 42 of the battery module 40. Specifically, the ultrasonic sensor 48 may be disposed on the bottom portion 42 of the carrying portion 442. The bottom portion 42 of the battery module 40 may face the ground. Thus, the ultrasonic sensor 48 may measure the distance of the UAV 100 from the ground, so that the flying height of the UAV 100 may be controlled to ensure that the flight safety of the UAV 100.

A visual sensor 49 may be configured on the bottom portion 42 of the battery module 40. Specifically, the ultrasonic sensor 48 may be disposed on the bottom portion 42 of the carrying portion 442. The visual sensor 49 may be, for example, a binocular visual sensor 49. Visual sensor 49 may acquire images under the UAV 100. Through image processing, the UAV 100 may determine a flight altitude and obstacles around the UAV 100, so that the UAV 100 may avoid obstacles in time to fly safely.

A gimbal 50 may be disposed on the bottom 11 of the fuselage 10. The gimbal 50 and the battery module 40 may be respectively located on opposite sides of the fuselage 10. Specifically, the gimbal 50 may be located on the front side of the bottom 11 of the fuselage 10, and the battery module 40 may be located on the rear side of the bottom 11 of the fuselage 10.

In some embodiments, the number of the gimbals 50 may be two, and the two gimbals 50 may be configured side-by-side on the same side of the fuselage 10. For example, the two gimbals 50 may be placed side-by-side on the front side of the fuselage 10. The battery module 40 may be located on a center line connecting the two gimbals 50.

The gimbal 50 may include a connecting member 51 and a bracket 52. The connecting member 51 may be coupled to the bottom 11 of the fuselage 10. For example, the connecting member 51 may be fixed to the bottom 11 of the fuselage 10 by screws. The bracket 52 may be coupled to the connecting member 51 and may be rotatable relative to the connecting member 51. For example, the bracket 52 may be coupled to the connecting member 51 via a joint motor. The connecting member 51 may be coupled to a stator of the joint motor, and the bracket 52 may be coupled to a rotor of the joint motor, so that the bracket 52 may be rotated relative to the connecting member 51 when the joint motor is in operation.

The gimbal 50 may carry a load 60. The load 60 may be mounted on the bracket 52. The load 60 may cause UAV 100 to complete a predetermined task during flight. In one example, the load 60 may be a camera so that the UAV 100 may perform shooting during the flight. The gimbal 50 may reduce vibration of the camera so that the camera can shoot stably.

In another example, the load 60 may be a cargo that is suspended on the gimbal 50, such as a key. The user may use the UAV 100 to send the key to a ground floor from an upper floor. The load 60 may be rotatable about a yaw axis 104 in 360 degrees with respect to the gimbal 50, so that when the load 60 is a camera, the load 60 may be panned for panoramic images. The yaw axis 104 may be defined as extending in the height direction of the UAV 100, e. g., the yaw axis 104 is in a vertical direction in FIG. 1.

In the direction of the flight height of the UAV 100, the bottom portion 42 of the battery module 40 may be higher than the load 60. In other words, the battery module 40 may be located above the load 60.

In the embodiments of the present disclosure, the battery module 40 may be disposed at the bottom 11 of the fuselage 10. This configuration may help to lower the center of gravity of the UAV 100, thus improving wind resistance performance of the UAV 100. Further, the above configuration may eliminate the need to configure an insertion aperture in the fuselage 10 for mounting the battery, thus simplifying the manufacture process of the UAV 100.

Further, the battery module 50 and the gimbal 40 may be positioned on opposite sides of the fuselage 10, so that the center of gravity of the UAV 100 may approximately overlap with a geometrical center of the UAV, thus improving flight capabilities of the UAV 100. Further, the bottom portion 42 of the battery module 40 may be configured higher than the load 60 to prevent interference with the battery module 40 when the load 60 is rotated about the yaw axis 104. In certain embodiments, the gimbal 50 may be located on the rear side of the bottom 11 of the fuselage 10 and the battery module 40 may be located on the front side of the bottom 11 of the fuselage 10.

In the present disclosure, the description with reference to the terms “an embodiment”, “some embodiments”, “certain embodiments”, and the like may refer to features, structures, materials or characteristics exist in at least one embodiment or example of the disclosure. The features, structures, materials, or characteristics described may be combined in a suitable manner in any one or more embodiments or examples.

While the embodiments of the present disclosure have been shown and described, a person skilled in the art will appreciate that various changes, modifications, alterations and variations can be made to the embodiments without departing from the spirit and scope of the disclosure.

What is claimed is:

1. An unmanned aerial vehicle (UAV), comprising:
a fuselage having a bottom facing a ground level; and
a battery module including a battery, the battery having a top portion facing the bottom of the fuselage, and being disposed below the bottom of the fuselage.

2. The UAV according to claim 1, wherein:
the battery module further includes a battery connection base;
the battery connection base is coupled to the bottom of the fuselage; and
the battery connection base and the bottom of the fuselage form a battery compartment for housing the battery.

3. The UAV according to claim 1, wherein the battery is longitudinally disposed on the bottom of the fuselage along a roll axis of the fuselage.

4. The UAV according to claim 3, wherein a projected area of the fuselage toward the battery module is larger than a projected area of the battery module toward a downward direction.

5. The UAV according to claim 2, wherein:
the battery connection base further includes a circuit board and an electric connector;
the battery further includes an electric connection terminal;
the electric connection terminal is electrically connected to the electric connector; and
the circuit board is electrically connected to the fuselage.

6. The UAV according to claim 2, wherein:
the battery connection base includes a connecting portion and a carrying portion;
the circuit board is disposed in the connecting portion;
the carrying portion is parallel to the bottom of the fuselage; and
the battery compartment is formed between the carrying portion and the bottom of the fuselage.

7. The UAV according to claim 6, wherein a bottom end of the carrying portion is provided with an ultrasonic sensor.

8. The UAV according to claim 6, wherein a bottom end of the carrying portion is provided with a binocular vision sensor.

9. The UAV according to claim 6, wherein the connecting portion is provided with a power switch.

10. The UAV according to claim 6, wherein the connecting portion is provided with a light indicator.

11. The UAV according to claim 2, wherein the battery is slidably disposed in the battery compartment along a roll axis of the fuselage.

12. The UAV according to claim 1, wherein the UAV further includes a gimbal disposed on the bottom of the fuselage, and the gimbal and the battery module are respectively located on two opposite ends of the fuselage.

13. The UAV according to claim 12, wherein the gimbal is located at a front end of the bottom of the fuselage, and the battery module is located at a rear end of the bottom of the fuselage.

14. The UAV according to claim 12, wherein:
the gimbal is a first gimbal;
the UAV further includes a second gimbal; and
the first gimbal and the second gimbal are placed side-by-side at a same end of the fuselage.

15. The UAV according to claim 12, wherein the gimbal is provided with a load.

16. The UAV according to claim 15, wherein a bottom end of the battery is higher than the UAV load.

17. The UAV of claim 15, wherein the load includes a camera.

18. The UAV according to claim 13, wherein the load is rotatable for 360° about a yaw axis with respect to the gimbal.
